(19) United States
(12) Patent Application Publication
(10) Pub. No.: US 2002/0101333 A1
(43) Pub. Date: Aug. 1, 2002

(54) Siren

(76) Inventor: John Lu, Taiping City (TW)

Correspondence Address: Jackson Walker L.L.P., Suite 2100, 112 E. Pecan Street, San Antonio, TX, 78205, US

(21) Appl. No.: 09/738,652

(22) Filed: Dec. 15, 2000

(51) Int. Cl. G08B 3/00

(52) U.S. Cl. 340/384.1; 340/388.1

(57) ABSTRACT

A siren has a housing, a motor, an acoustic actuator and a horn. Multiple vents are defined in the housing. The acoustic actuator is rotatably mounted in the housing and is rotated by the motor. The horn is mounted on the housing to provide a resonant effect. Accordingly, the air can be drawn into the housing through the vents by the acoustic actuator. The sound will generated by the impact between air and each block in the acoustic actuator and the interruption of the airflow by the blocks. Consequently, the process for assembling the siren is simplified. The sound quality of the siren will be consistent and improved.

### BACKGROUND OF THE INVENTION

1. Field of the Invention

The present invention relates to a siren, and more particularly to a siren with a rotating acoustic actuator to make the sound.

2. Description of Related Art

An air horn is mounted in a vehicle like a truck to send out a loud sound as a warning. The conventional air horn in accordance with the prior art substantially comprises a hollow body, a diaphragm and a horn. The body is connected to a source of compressed air. The diaphragm is mounted in the body so that it will vibrate. The horn is mounted on and communicates with the body. When the air is directed into the hollow body and hits the diaphragm, the diaphragm will vibrate. The horn resonates, and a loud sound is generated by the vibration of the diaphragm. This can provide a warning to other people or another vehicle. However, because the sound of the conventional air horn is created by the vibration of the diaphragm, the quality of the sound depends on the quality in the assembly of the diaphragm, e.g. the sound quality will reduce when the diaphragm is mounted on the body too tightly or loosely. Therefore, the assembly of the conventional air horn is difficult, and the quality of the conventional air horn is inconsistent.

To overcome the shortcomings, the present invention tends to provide a siren to mitigate or obviate the aforementioned problems.

### SUMMARY OF THE INVENTION

The main objective of the invention is to provide a siren that will send out a loud sound and is easily assembled. The siren in accordance with the present invention has a housing, a motor, an acoustic actuator and a horn. multiple vents are defined in the housing. The acoustic actuator is rotatably mounted in the housing and is rotated by the motor. The horn is mounted on the housing to provide a resonant effect. By such an arrangement, the air can be drawn into the housing through the vents by the acoustic actuator. The sound will be generated by the impact between air and each block in the acoustic actuator and the interruption of the airflow by the blocks. Accordingly, the assembly of the siren is simplified.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a siren in accordance with the present invention;

FIG. 2 is an exploded perspective view of the siren in FIG. 1;

FIG. 3 is a side plan view in partial section of the siren in FIG. 1; and

FIG. 4 is a cross sectional front view of the siren taken along line 4-4 in FIG. 3.

### DETAILED DESCRIPTION OF PREFERRED EMBODIMENT

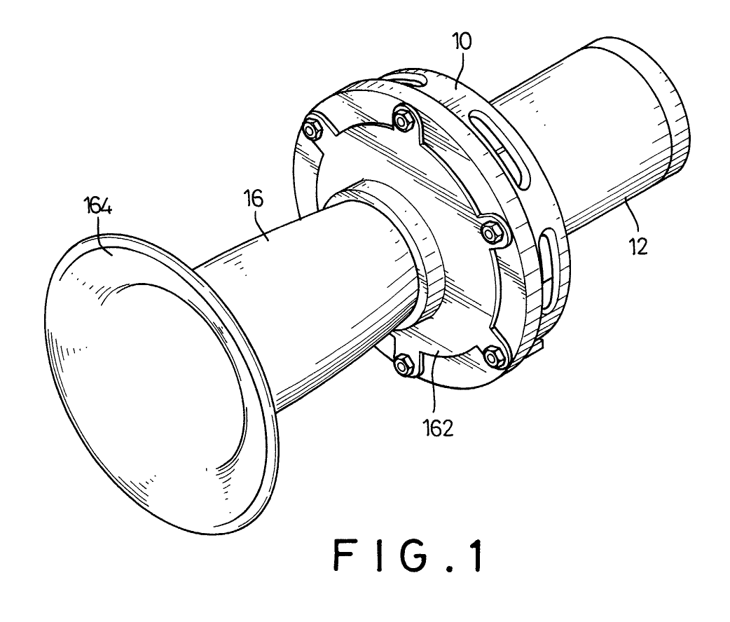

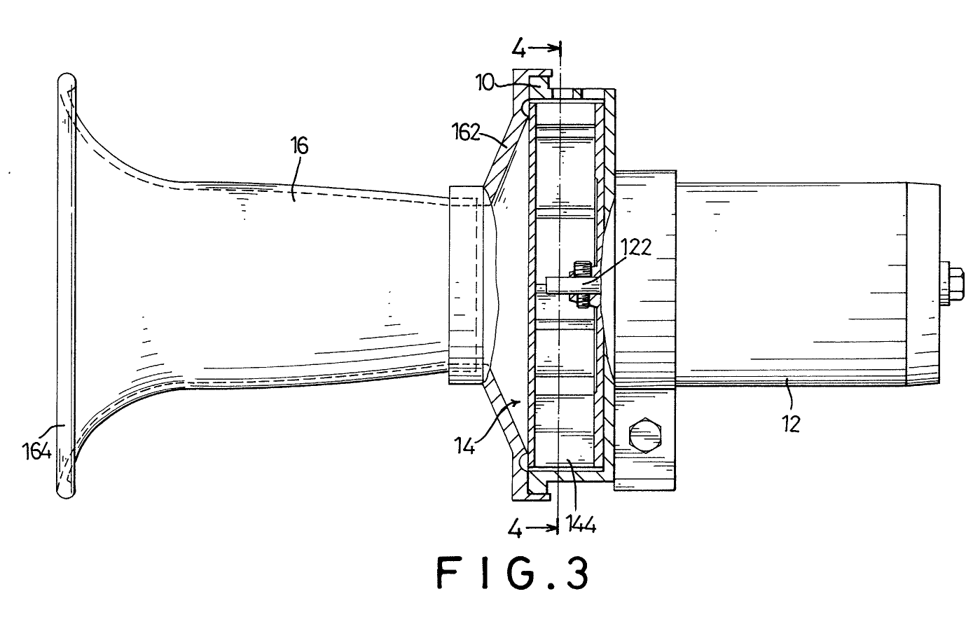

With reference to FIGS. 1 to 3, a siren in accordance with the present invention comprises a housing (10), a motor (12), an acoustic actuator (14) and a horn (16). Multiple vents (102) are defined around the housing (10), and the housing (10) has an open end and a closed end. The motor (12) is securely mounted on the closed end of the housing (10). The motor (12) has a rotating shaft (122) extending into the housing (10). The acoustic actuator (14) is rotatably mounted in the housing (10) and connected to the shaft (122) of the motor (12). The acoustic actuator (14) is composed of a rear plate (142), multiple curved blocks (144) and an annular front plate (146). The rear cover (142) is secured to the shaft (122) of the motor (12) with setscrews. The blocks (144) are mounted apart from each other on the periphery of one side of the rear plate (142). The front plate (146) is attached to the blocks (144) to cover all of the blocks (144), such that an air channel is defined between adjacent blocks (144).

One end of the horn (16) is mounted on the open end of the housing (10). An enlarged cover (162) is formed on one end of the horn (16) to cover the open end of the housing (10). A bell (164) is formed on the other end of the horn (16).

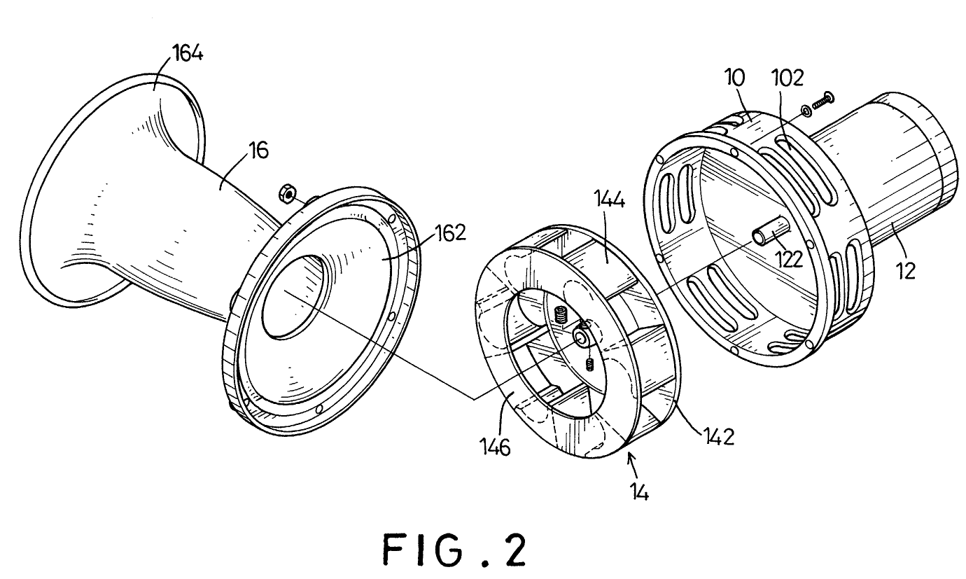

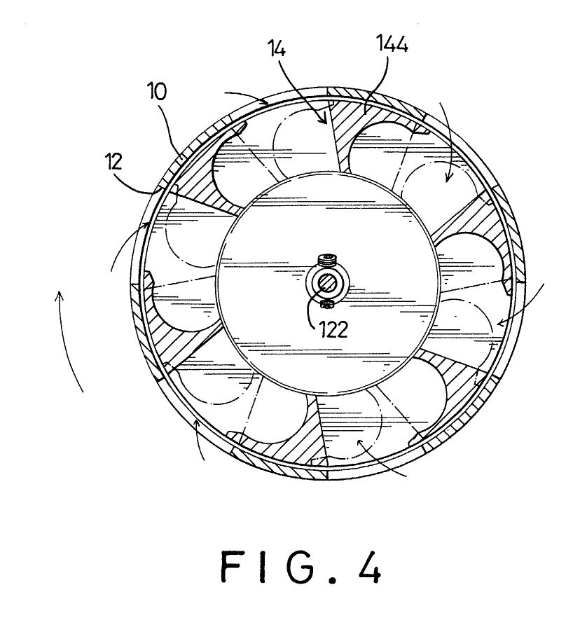

With reference to FIGS. 2 to 4, when the motor (12) runs, the acoustic actuator (12) rotates with the shaft (122) of the motor (12). Air will be drawn into the housing (10) through the vents (122) by the curved blocks (144) in the acoustic actuator (14). The air passes through each air channel and out the central hole in the annular front cover (146). Consequently, the air impacts the blocks (144) and sound occurs. In addition, when each block (144) aligns with one of the vents (122), the airflow will be interrupted. This can further cause the occurrence of sound. Furthermore, the horn (16) provides a resonant effect to the sound, such that a loud sound will be sent out from the horn (16).

Because all of the elements of the siren can be assembled by fasteners such as bolts, the process for assembling the siren is simplified. In addition, because the sound of the siren is generated due to the impact between the air and each block (144) but not the vibration of a diaphragm, the sound quality of the siren is consistent and improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A siren comprising:
a housing having multiple vents defined through a side face of the housing, an open end and a closed end;
an acoustic actuator rotatably mounted in the housing;
a motor with a rotating shaft mounted on the closed end of the housing to rotate the acoustic actuator; and
a horn mounted on the housing to cover the open end of the housing to enclose the acoustic actuator within the housing.

2. The siren as claimed in claim 1, wherein the acoustic actuator is composed of:
a rear plate secured to the rotating shaft of the motor;
multiple curved blocks separately arranged on a periphery of one side of the rear plate; and
an annular front plate attached to all of the blocks to form an air channel between adjacent blocks.

3. The siren as claimed in claim 1, wherein an enlarged cover is formed on one end of the horn to connect with the housing.

4. The siren as claimed in claim 3, wherein a bell is formed on the other end of the horn.
